(19) United States
(12) Patent Application Publication
(10) Pub. No.: US 2025/0375064 A1
(43) Pub. Date: Dec. 11, 2025

(54) MIXING APPLIANCE AND CONTROL SWITCH ASSEMBLY

(71) Applicant: WHIRLPOOL CORPORATION, BENTON HARBOR, MI (US)

(72) Inventors: DAN CHRISTIAN BARFUSS, SAINT JOSEPH, MI (US); JACOB W. EVERIDGE, SAINT JOSEPH, MI (US); SHEETAL PANDITA, PUNE (IN); POONAM PAWAR, PUNE (IN); JOSEPH SNYDER, BENTON HARBOR, MI (US)

(21) Appl. No.: 18/735,343

(22) Filed: Jun. 6, 2024

(51) Int. Cl. A47J 43/044; A47J 43/08

(52) U.S. Cl. CPC A47J 43/044; A47J 43/082; A47J 2043/04454

(57) ABSTRACT

A mixing appliance and control switch assembly includes a drive shaft configured to couple to a mixing tool, and an electric motor driving rotation of the drive shaft. A control switch assembly is operably coupled to the electric motor for operation of the mixing appliance. The control switch assembly includes a switch path, an actuator movable along the switch path, and a position sensor assembly configured to sense a position of the actuator along the switch path.

### TECHNICAL FIELD

The present disclosure relates to mixing appliances for processing food items, and more specifically to an electric mixing appliance having a control switch for providing multiple output speeds.

### BACKGROUND

Electrical appliances for processing or mixing food items can take many forms, such as blenders, food processors, mixers, and the like. Such appliances typically include a drive assembly including an electric motor and a gearbox located in a housing. The drive assembly is arranged to rotate, at a desired speed, an output shaft coupled to a work piece such as a blade, paddle, or other implement used to perform various operations such as blending, mixing, beating, whipping, stirring, kneading, chopping and the like, on a food item or ingredient. Such electrical appliances can include a switch or speed control mechanism for operating the appliance at multiple output speeds.

### BRIEF SUMMARY

In one aspect, the disclosure relates to an electric mixing appliance, including a drive shaft configured to couple to a mixing tool, an electric motor operably coupled to the drive shaft for driving rotation of the drive shaft, a control switch assembly operably coupled to the electric motor and having a switch path selectively defining a first configuration with motion detents, and a second configuration without motion detents, an actuator movable along the switch path, and a position sensor assembly configured to sense a position of the actuator along the switch path, and a controller module communicatively coupled to the electric motor and the position sensor assembly, and configured to operate the electric motor based on the sensed position.

In another aspect, the disclosure relates to a control switch assembly for an electric mixing appliance, including a switch path defining at least two positions corresponding to an operational speed of the electric mixing appliance, a slider movable along the switch path, a switch motor operably coupled to the slider for driving motion along the switch path, and a position sensor assembly configured to sense a position of the slider along the switch path, wherein the switch path selectively defines a first configuration having motion detents, and a second configuration without motion detents.

### BRIEF DESCRIPTION OF THE DRAWINGS

In the drawings:

FIG. 1 illustrates a perspective view of an exemplary electric mixing appliance in accordance with various aspects as described herein.

FIG. 2 is a schematic diagram of a control switch assembly that can be utilized with the electric mixing appliance of FIG. 1 in accordance with various aspects described herein.

FIG. 3 is a schematic perspective view of the control switch assembly of FIG. 2.

FIG. 4 is a schematic cutaway view of the control switch assembly of FIG. 2 illustrating a position sensor assembly in accordance with various aspects described herein.

FIG. 5 is a schematic perspective view of the position sensor assembly of FIG. 4 in accordance with various aspects described herein.

FIG. 6 is a schematic diagram of another control switch assembly that can be utilized with the electric mixing appliance of FIG. 1 in accordance with various aspects described herein.

FIG. 7 is a schematic perspective view of the control switch assembly of FIG. 6 and illustrating a threaded shaft assembly in accordance with various aspects described herein.

FIG. 8 is a schematic diagram of another control switch assembly that can be utilized with the electric mixing appliance of FIG. 1 in accordance with various aspects described herein.

FIG. 9 is a schematic diagram of another control switch assembly that can be utilized with the electric mixing appliance of FIG. 1 in accordance with various aspects described herein.

FIG. 10 is a schematic diagram of another control switch assembly that can be utilized with the electric mixing appliance of FIG. 1 in accordance with various aspects described herein.

### DETAILED DESCRIPTION

Electric mixing appliances such as blenders, mixers, food processors, kneading machines, and the like, typically use an electric motor to rotate a spindle or shaft coupled to a tool, such as a blade, whisk, beater, or other mixing implement. One or more ingredients or food items are placed in a vessel, and the rotating tool is brought into engagement with the ingredients in the vessel to perform the desired mixing operation. Various food items or ingredients can have differing respective viscosities, densities, or the like which can necessitate use of different torques or rotational speeds of the tool to accomplish the desired mixing operation. For at least this reason, many conventional mixing appliances can be operated at more than one speed. In some cases, an electronic speed control can be used to control the speed of the motor.

Aspects of the present disclosure provide for an electric mixing appliance having multiple operating speeds that are selected by a configurable control switch. The control switch can be manually operated in some examples. Aspects also provide for remote control or operation of the control switch, such as by way of a remote user interface, a remote device, an application on a mobile device or smartphone, or the like. Aspects further provide for configuration of the control switch to selectively provide or remove motion detents along a switch path. In a first configuration, motion detents can be engaged or present for discrete speed selection, providing for quickly-accessed, tactile speed selection from a discrete number of options. In a second configuration, motion detents can be disengaged or removed for a smooth or continuous speed selection, providing for more precise selection of speeds over the entire switch path.

It is to be understood that the specific devices and processes illustrated in the attached drawings and described in the following specification are simply exemplary non-limiting aspects of the disclosure herein. Hence, specific dimensions and other physical characteristics relating to the aspects disclosed herein are not to be considered as limiting.

In describing aspects illustrated in the drawings, specific terminology will be resorted to for the sake of clarity. However, it is not intended that the aspects be limited to the specific terms so selected and it is to be understood that each specific term includes all technical equivalents that operate in a similar manner to accomplish a similar purpose. For example, the words “connected,” “attached,” “coupled,” “engaged”, and “mounted” and variations thereof herein are used broadly and encompass direct and indirect connections, attachments, couplings, engagements, and mountings. In addition, the terms “connected,” “coupled,” etc. and variations thereof are not restricted to physical or mechanical connections, couplings, etc. as all such types of connections should be recognized as being equivalent by those skilled in the art.

Additionally, as used herein, a “processor,” or “controller module” can include a component configured or adapted to provide instruction, control, operation, or any form of communication for operable components to affect the operation thereof. A processor or controller module can include any known processor, microcontroller, or logic device, including, but not limited to: Field Programmable Gate Arrays (FPGA), an Application Specific Integrated circuit (ASIC),a Proportional controller (P), a Proportional Integral controller (PI), a Proportional Derivative controller (PD), a Proportional Integral Derivative controller (PID controller), a hardware-accelerated logic controller (e.g. for encoding, decoding, transcoding, etc.), the like, or a combination thereof. Non-limiting examples of a controller module can be configured or adapted to run, operate, or otherwise execute program code to effect operational or functional outcomes, including carrying out various methods, functionality, processing tasks, calculations, comparisons, sensing or measuring of values, or the like, to enable or achieve the technical operations or operations described herein. The operation or functional outcomes can be based on one or more inputs, stored data values, sensed or measured values, true or false indications, or the like. While “program code” is described, non-limiting examples of operable or executable instruction sets can include routines, programs, objects, components, data structures, algorithms, etc., that have the technical effect of performing particular tasks or implement particular abstract data types. In another non-limiting example, a processor or controller module can also include a data storage component accessible by the processor, including memory, whether transient, volatile or non-transient, or non-volatile memory.

Additional non-limiting examples of the memory can include Random Access Memory (RAM), Read-Only Memory (ROM), flash memory, or one or more different types of portable electronic memory, such as discs, DVDs, CD-ROMs, flash drives, universal serial bus (USB) drives, the like, or any suitable combination of these types of memory. In one example, the program code can be stored within the memory in a machine-readable format accessible by the processor. Additionally, the memory can store various data, data types, sensed or measured data values, inputs, generated or processed data, or the like, accessible by the processor in providing instruction, control, or operation to affect a functional or operable outcome, as described herein. In another non-limiting example, a control module can include comparing a first value with a second value, and operating or controlling operations of additional components based on the satisfying of that comparison. For example, when a sensed, measured, or provided value is compared with another value, including a stored or predetermined value, the satisfaction of that comparison can result in actions, functions, or operations controllable by the controller module. As may be used herein, the term “satisfies” or “satisfaction” of the comparison will be used herein to mean that the first value satisfies the second value, such as being equal to or less than the second value, or being within a predetermined value range of the second value. It will be understood that such a determination may easily be altered to be satisfied by a positive/negative comparison or a true/false comparison. Example comparisons can include comparing a sensed or measured value to a threshold value or threshold value range.

Additionally, as used herein, elements being “electrically connected,” “electrically coupled,” or “in signal communication” can include an electric transmission or signal being sent, received, or communicated to or from such connected or coupled elements. Furthermore, such electrical connections or couplings can include a wired or wireless connection, or a combination thereof.

All directional references (e.g., radial, axial, proximal, distal, upper, lower, upward, downward, left, right, lateral, front, back, top, bottom, above, below, vertical, horizontal, clockwise, counterclockwise, upstream, downstream, forward, aft, etc.) are only used for identification purposes to aid the reader's understanding of the present disclosure, and do not create limitations, particularly as to the position, orientation, or use of the disclosure. Furthermore, as used herein, the term “set” or a “set” of elements can be any number of elements, including only one. The exemplary drawings are for purposes of illustration only and the dimensions, positions, order and relative sizes reflected in the drawings attached hereto can vary.

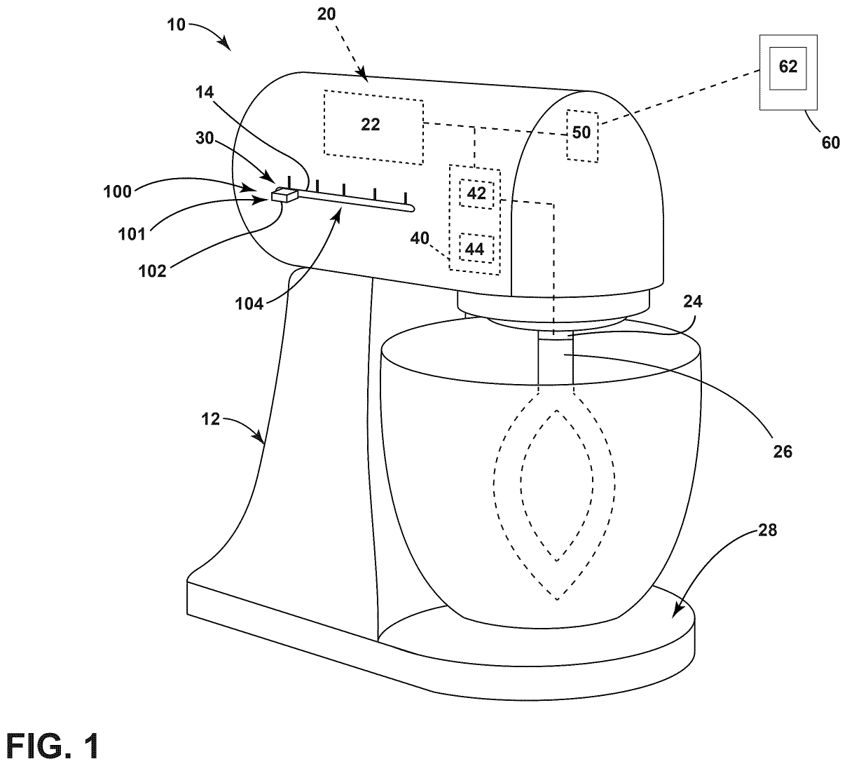

Referring now to FIG. 1, an exemplary electric mixing appliance 10 is shown in the form of a stand mixer. It will be understood that aspects of the disclosure can be applicable to other mixing appliances, such as blenders, mixers, food processors, kneading machines, and the like.

The electric mixing appliance 10 (also referred to herein as “mixing appliance 10”) can include a housing 12 and a drive assembly 20. The drive assembly 20 can include a motor 22 operably coupled to a rotatable output shaft 24. In some implementations, the motor 22 and the output shaft 24 can have a common rotational speed. In some implementations, a gear assembly can be provided such that the motor 22 and the output shaft 24 can operate with different rotational speeds.

The output shaft 24 can be configured to couple to a mixing tool 26, such as a flat beater, a whisk, a dough hook, or the like. It is contemplated that the output shaft 24 can be configured for coupling to multiple mixing tools 26. The mixing tool 26 can extend into a food preparation zone 28 into which selected food items or ingredients can be placed for processing. In the non-limiting example shown, the food preparation zone 28 includes a vessel or bowl positioned on a portion of the housing 12, though this need not be the case. In other implementations, the food preparation zone 28 can include a flat surface, a baking sheet, a cup, or the like.

The mixing appliance 10 can also include a user interface 30. The user interface 30 can include one or more user-engageable elements, such as a knob, toggle, slider, button, touch screen, or the like, to enable a user to operate one or more functions of the mixing appliance 10.

A control switch assembly (or “switch assembly”) 100 can be provided for operating the mixing appliance 10 at a selected or desired operational speed. As described above, the motor 22 and the output shaft 24 may have the same or different rotational speeds during operation. It will be understood that the rotational speed of the motor 22 can be proportional to the rotational speed of the output shaft 24, such that (for example) an increase or decrease in the motor 22 speed generates a correlating increase or decrease in the output shaft 24 or mixing tool 26 speed, and vice versa.

The switch assembly 100 includes an actuator 101 which, in the non-limiting example shown, includes a slider 102 extending through a channel 14 in the housing 12. It is understood that the actuator 101 can have any suitable form, including other elements such as a knob, dial, touch screen, push button, or the like, in non-limiting examples.

The slider 102 can be movable along a switch path 104 as shown. The switch path 104 can correspond to or underlie the channel 14 in some implementations. The channel 14 can also at least partially define the switch path 104 in some examples. In addition, a number of positions can be arranged along the switch path 104 each corresponding to a selected rotational speed. In the illustrated example, five positions are shown although any number can be provided.

A controller module 40 is also provided and can be communicatively coupled to the switch assembly 100 for operation of the mixing appliance 10 based on a position of the slider 102. The controller module 40 can include a number of electronic components commonly associated with electronic units utilized in the control of electromechanical systems. More specifically, the controller module 40 can include a processor 42 and a memory 44. The processor 42 can include a central processing unit (CPU) and can be any type of device capable of executing software or firmware, such as a microcontroller, microprocessor, digital signal processor, or the like. For example, it is contemplated that the processor 42 can be a microprocessor-based controller that implements control software and sends/receives one or more electrical signals to/from each of the various working components to effect control software.

The memory 44 can be embodied as one or more non-transitory, machine-readable media. The memory 44 can be configured to store, amongst other things, instructions in the form of, for example, a software routine (or routines) which, when executed by the processor 42, allows the controller module 40 to control operation of the mixing appliance 10. The memory 44 can be used for storing the control software that is executed by the processor 42 in performing a selected operation to be executed by the mixing appliance 10 and any additional software. For example, the memory 44 can store a set of executable instructions including at least one user-selectable operation. The memory 44 can also be used to store information, such as a database or table, and to store data received from one or more components of the mixing appliance 10 that can be communicably coupled with the controller module 40. The database or table can be used to store the various operating parameters for the one or more operations, including factory or default values for the operating parameters and any adjustments to them by the controller module 40 or by the user interface 30.

The controller module 40 can be communicatively coupled to the drive assembly 20, including the motor 22, as well as the user interface 30, including the control switch assembly 100. In this manner, the controller module 40 can operate the mixing appliance 10 at the speed selected by the switch assembly 100 by way of controllably operating the motor 22.

The mixing appliance 10 can also be remotely operated or controlled in some examples. As shown, a communication link 50 is provided and can include any variety of communication mechanism capable of linking with other systems or devices, such as a wired connection, Wireless Fidelity (WiFi), Bluetooth, 3G wireless signal, code division multiple access (CDMA) wireless signal, 4G wireless signal, long term evolution (LTE) signal, or the like, in non-limiting examples. As shown, an exemplary remote device 60 having a remote user interface 62 can be communicatively coupled to the controller module 40 by way of the communication link 50. In this manner, a user can operate one or more functions of the mixing appliance 10 by way of either or both of the remote user interface 62 or the user interface 30. In some implementations, the user interface 30 on the housing 12 can be eliminated and the mixing appliance 10 can be fully controlled by way of the remote user interface 62.

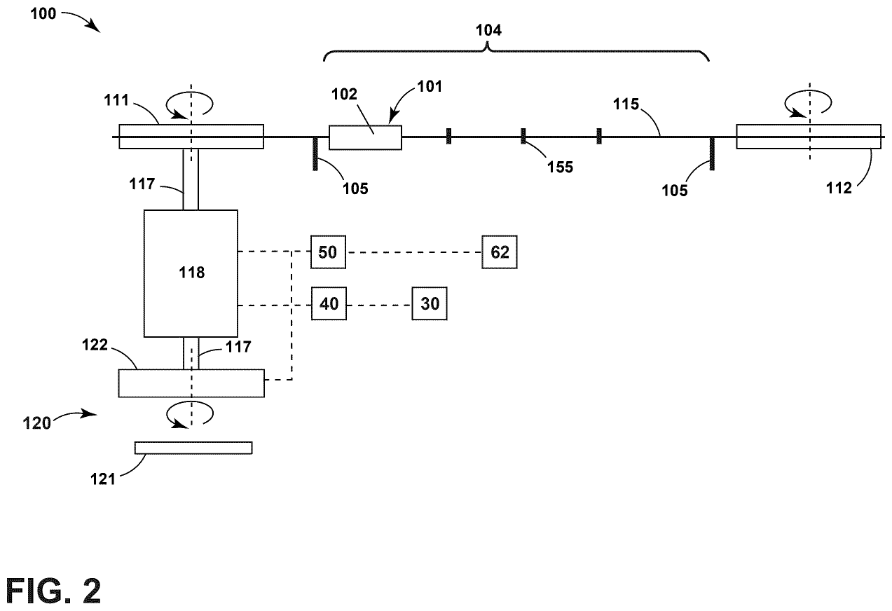

Referring now to FIG. 2, a schematic view illustrates additional non-limiting aspects of the control switch assembly 100. In the example shown, the switch assembly 100 includes firstand secondpulleys 111, 112 and a belt 115 fitted about the pulleys 111, 112. Any number of pulleys can be provided. The switch assembly 100 can also include a switch motor 118 with a shaft 117 and configured to drive motion of the slider 102.

The switch assembly 100 can further include a position sensor assembly 120. The position sensor assembly 120 includes a position sensor 121, such as a Hall effect sensor in a non-limiting example. The position sensor assembly 120 can also include an encoder 122, such as a linear encoder, a rotational encoder, an optical encoder, a magnetic encoder, or the like, for providing a signal corresponding to motion of the slider 102. Any suitable encoder can be provided. In the non-limiting example shown, the position sensor 121 includes a Hall-effect sensor (also referred to herein as “Hall sensor”) and the encoder 122 includes a ring magnet spaced from the Hall sensor or position sensor 121. The encoder 122 can be mounted to the shaft 117 for co-rotation with the pulleys, such as the first pulley 111. More specifically, the position sensor 121 can be in the form of an angular Hall sensor for detecting a rotational position or orientation of the ring magnet or encoder 122.

While the position sensor assembly 120 is described as including a Hall sensor and ring magnet, it is contemplated that the position sensor assembly 120 can include any suitable component for sensing or detecting a position of the slider 102 along the switch path 104. For instance, in one non-limiting example, the position sensor 121 can include a linear variable resistor operably coupled to the slider 102 and providing an output signal indicative of its position along the switch path 104. In another non-limiting example, the position sensor 121 can be mounted to the shaft 117. In such a case, the encoder 122 can optionally be omitted, providing for reduced complexity and assembly costs. Alternatively, in such a case, the encoder 122 can optionally be included for transmitting secondary position signals in addition to signal outputs from the the position sensor 121 on the shaft 117, providing redundancy in position sensing and increased robustness for the system.

In still another non-limiting example, the position sensor 121 can include a pair of Hall sensors, and the encoder 122 can include a ring magnet with two or more circumferentially-arranged magnetic poles. Each Hall sensor can detect magnetic field transitions corresponding to alternating magnetic poles during rotation of the ring magnet. In such a case, the controller module 40 can receive or compare signals from each Hall sensor, including determining a number of pole transitions per second, comparing a timing between received signals from each Hall sensor, or the like. The controller module 40 can additionally determine a speed of the ring magnet, or a rotational direction of the ring magnet, or the like.

Regardless of the specific form of the position sensor assembly 120, it will be understood that the position sensor 121 can be configured to sense or detect a position of the slider 102 along the switch path 104. In some examples, the position sensor assembly 120 can provide discrete output signals indicative of the slider 102 moving into discrete positions along the switch path 104. Additionally or alternatively, the position sensor assembly 120 can provide continuous output signals corresponding to the slider 102 moving or being located at any position along the switch path 104.

Still referrering to FIG. 2, the switch motor 118 can be operably coupled to the belt 115. In the illustrated example, a shaft 117 couples the switch motor 118 to the encoder 122 and to the first pulley 111 for driving the belt 115, though this need not be the case. The switch motor 118 can be operably coupled to any of the pulleys 111, 112. In addition, as shown, the switch motor 118 and the position sensor assembly 120 are in signal communication with each of the controller module 40 and the communication link 50 though this need not be the case. It is contemplated that either or both of the switch motor 118 or the position sensor assembly 120 can be communicatively coupled to the controller module 40 alone, or to the communication link 50 alone. Furthermore, the switch motor 118 can include any suitable motor for operating the control switch assembly 100, including a direct-current (DC) motor, an alternating-current (AC) motor, a stepper motor, a brushed motor, a brushless motor, or the like in some implementations.

One or more stops 105 can be provided for limiting motion of the slider 102 along the switch path 104. While the stops 105 are schematically illustrated as discrete components, it is contemplated that the stops 105 can be incorporated or defined by other components, e.g. the first and second pulleys 111, 112. Additionally or alternatively, one or more of the stops 105 can include an electronic limit switch.

Some exemplary motion detents 155 are illustrated along the switch path 104. Such motion detents 155 can include physical detents, e.g., gear teeth or projections, or electromagnetic or motor-generated detents, e.g., magnetic-catch detents or electrically-resistive detents, which may be selectively generated by the switch motor 118. It is also contemplated that the switch path 104 can be free of motion detents such that the slider 102 can freely move along the switch path 104. Furthermore, in some implementations a first portion of the switch path 104 can include motion detents and a second portion of the switch path 104 can have no motion detents.

The slider 102 can be coupled to the belt 115 such that motion of the belt 115 generates corresponding motion of the slider 102, and vice versa. The encoder 122 is also caused to rotate with the first pulley 111 due to motion of the belt 115 or the slider 102. The position sensor 121 can be configured to sense or detect a position, an orientation, a change in orientation, or the like of the encoder 122, which corresponds to a position of the slider 102 along the switch path 104.

In one example of operation, a user can manually adjust a position of the slider 102 along the switch path 104, causing the encoder 122 to rotate by way of the belt 115. The position sensor 121 can sense or detect such rotation of the encoder 122 and provide a signal indicative of a position of the slider 102.

In another example of operation, the switch motor 118 can drive motion of the belt 115 such that the slider 102 is moved to a predetermined position along the switch path 104. For instance, the switch motor 118 can be remotely controlled or operated by way of the remote user interface 62 and the communication link 50.

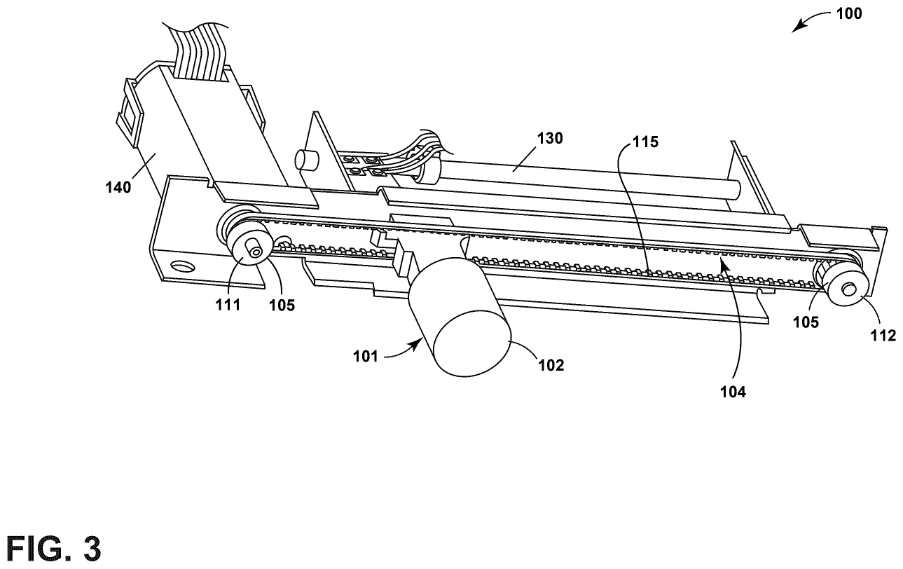

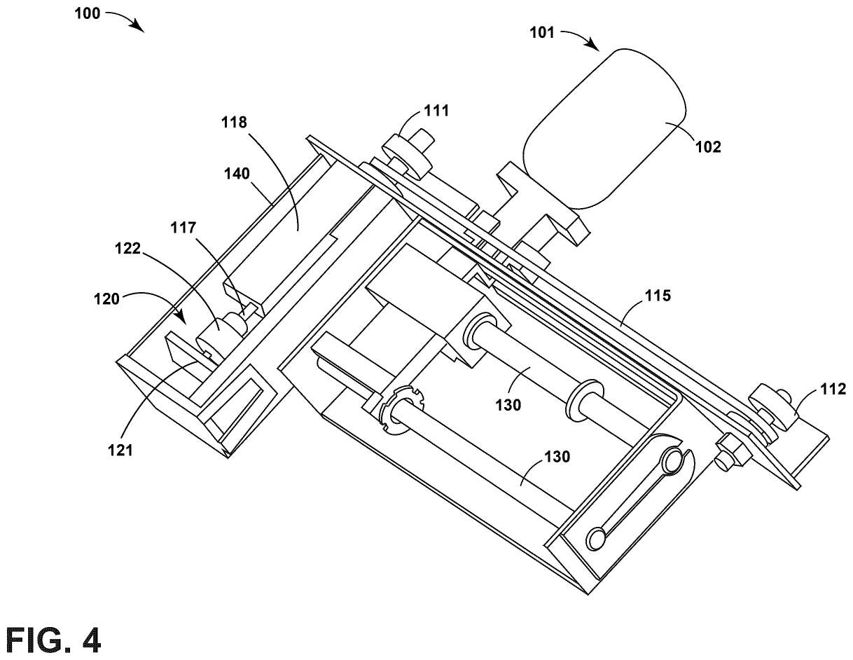

FIGS. 3-4 illustrate one exemplary implementation of the control switch assembly 100. As shown in FIG. 3, the slider 102 is movable along the switch path 104 with the first and second pulleys 111, 112 defining the stops 105. One or more guide rails 130 can also be provided for motion of the slider 102 along the switch path 104. In particular, two parallel guide rails 130 (FIG. 4) can be provided with the slider 102 extending across for improved motion stability during operation. In addition, the belt 115 and pulleys 111, 112 can also include gear teeth, serrations, flexible tabs, or the like, such as may be found in a pulley gear system, for reducing slip during operation.

The switch assembly 100 can also include a motor housing 140 as shown. The motor housing 140 can bound an interior space for housing various components or isolating movable components from one another. FIG. 4 illustrates the switch assembly 100 with a portion of the motor housing 140 removed. The switch motor 118, shaft 117, and position sensor assembly 120 including the position sensor 121 and the encoder 122 can be disposed within the motor housing 140 as shown. The slider 102 is shown having a body coupled to both guide rails 130 for slidable motion.

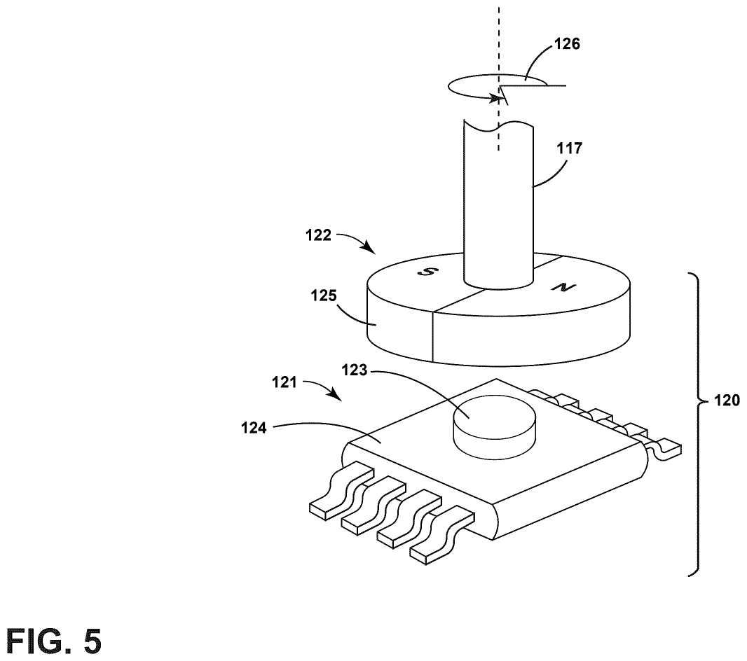

Turning to FIG. 5, one exemplary implementation is shown for the position sensor assembly 120. As shown, the position sensor 121 includes an angular Hall-effect sensor 123 and a printed circuit board (PCB) 124, and the encoder 122 includes a ring magnet 125. The angular Hall sensor 123 can be disposed adjacent to, and spaced from, the ring magnet 125. In addition, while the angular Hall sensor 123 is illustrated as a separate component from the PCB 124, it will be understood that the angular Hall sensor 123 can be integrated with the PCB 124 in some implementations.

The position sensor assembly 120 can generate or transmit an output signal, such as an analog voltage or a digital signal, corresponding to a magnetic flux density from the ring magnet 125. Such an output signal is based on an angular orientation 126 of the ring magnet 125, e.g., from 0-180°, or from 0-360°, as the ring magnet 125 and shaft 117 are rotated by the switch motor 118 (FIG. 4). In the example shown, the ring magnet 125 is in the form of a diametric magnet with two poles, although the ring magnet 125 can have any number of magnetic poles. During rotation, the ring magnet 125 generates a sinusoidally-varying magnetic field which is detected by the angular Hall sensor 123. In this manner, the position sensor assembly 120 can be configured to sense a position of the actuator 101 at any location along the switch path 104 (FIG. 2), including continuous position sensing along the switch path 104.

With general reference to FIGS. 1-5, during operation, the switch assembly 100 can have multiple configurations or modes corresponding to action or motion of the slider 102. In particular, the switch path 104 can have a discrete-speed configuration and a continuous-speed configuration providing for stepped or continuous motor speed adjustments, respectively.

In the discrete-speed configuration, the switch motor 118 can be operated to resist manual motion of the belt 115 when the actuator 101 or slider 102 is between discrete stops 105, and to reduce or remove motion resistance of the belt 115 when the actuator 101 is in proximity to one or more of the discrete motion detents 155. Put another way, the switch motor 118 can electrically define motion detents at discrete positions along the switch path 104 that provide tactile feedback to a user when manually adjusting the actuator 101. In some implementations, in the discrete-speed configuration, the switch motor 118 can electrically define between 2-40 motion detents 155 along the switch path 104. Any number of motion detents 155 can be provided.

In the continuous-speed configuration, the switch motor 118 can be operated to reduce or remove motion resistance of the belt 115 with no motion detents along at least a portion of the switch path 104. The actuator 101 or slider 102 can be smoothly moved or positioned along the switch path 104 for selecting a speed of the motor 22 (FIG. 1). In this manner, the switch path 104 can selectively define a first configuration with motion detents, such as the discrete-speed configuration, and a second configuration without motion detents, such as the continuous-speed configuration.

It is also contemplated that the switch motor 118 can be controlled or operated to provide motion detents 155 that are at least one of time-variable or position-variable along the switch path 104. For instance, the switch motor 118 can provide one or more motion detents along the switch path 104 during a first time interval, and remove at least one motion detent from the switch path 104 during a second time interval. In another example, the switch motor 118 can provide motion detents 155 with a non-constant spacing over portions of the switch path 104.

Furthermore, the switch motor 118 can be communicatively coupled to either or both of the user interface 30 or the remote device 60 for selective operation or control. For instance, the mixing appliance 10 can be operated in a remote mode, such as by way of the remote device 60, or in a manual mode, such as by way of the slider 102. Either or both of the user interface 30 or the remote user interface 62 can include a user-selectable option to select a configuration for the switch path 104, e.g. the discrete-speed or continuous-speed configuration, or to operate the switch assembly 100 in the selected configuration.

In one non-limiting example of operation, the remote device 60 can be used to place the switch path 104 in the discrete-speed configuration, and to operate the switch assembly 100 to move to a selected position, e.g., “Medium,” “Fold,” or the like. In another non-limiting example of operation, the remote device 60 can be used to place the control switch assembly 100 in the continuous-speed configuration, and to operate the control switch assembly 100 to adjust from a current position, e.g., “increase speed by 15%.” In still another non-limiting example, the mixing appliance 10 can include a switch on the housing 12 to select a configuration of the switch path 104, and the slider 102 can be manually moved or adjusted with or without electric motion detents 155.

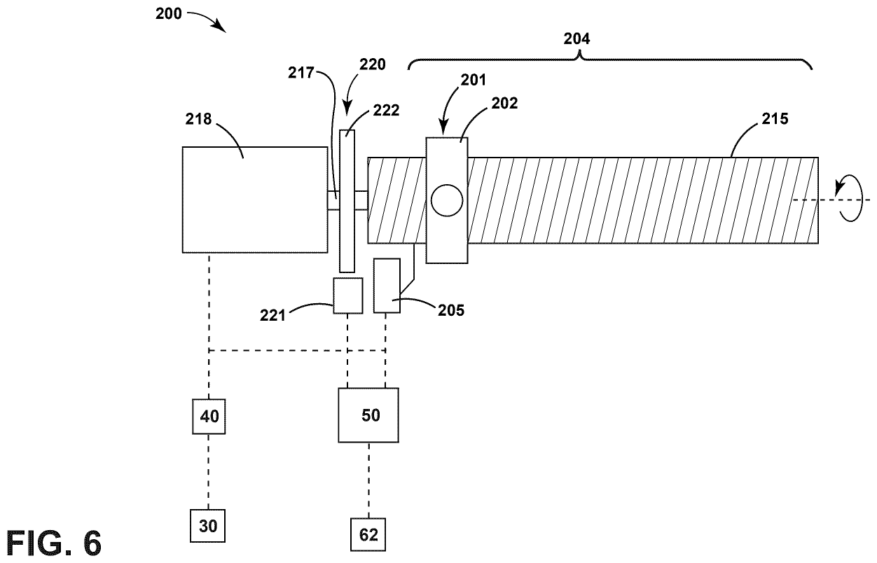

Turning to FIG. 6, another control switch assembly 200 is shown that can be utilized in the mixing appliance 10. The control switch assembly 200 is similar to the control switch assembly 100; therefore, like parts will be described with like numerals increased by 100, with it being understood that the description of the like parts of the control switch assembly 100 applies to the control switch assembly 200, unless noted otherwise.

In the example shown, the switch assembly 200 an actuator 201 in the form of a slider 202, as well as a switch motor 218 with a shaft 217, and a position sensor assembly 220. The position sensor assembly 220 can include a position sensor 221, such as a Hall sensor. The position sensor assembly 220 can also include an encoder 222, such as a ring magnet. Additionally, one or more stops 205 can be provided for limiting motion of the slider 202. As shown, one stop 205 includes an electronic limit switch adjacent the encoder 222 though this need not be the case.

One difference compared to the switch assembly 100 is that a threaded shaft 215 is provided and at least partially defines a switch path 204. The slider 202 can be threaded onto the shaft 215 such that rotation of the shaft 215 generates lateral motion of the slider 202 along the switch path 204, and vice versa. The encoder 222 is also caused to rotate due to motion of the shaft 215 or the slider 202. The position sensor 221 can be configured to sense or detect an orientation, change in orientation, or the like of the encoder 222, which corresponds to a position of the slider 202 along the switch path 204.

The switch motor 118 can be operably coupled to the shaft 215. In addition, as shown, the switch motor 218 and the position sensor assembly 220 are in signal communication with each of the controller module 40 and the communication link 50 though this need not be the case. It is contemplated that either or both of the switch motor 218 or the position sensor assembly 220 can be communicatively coupled to the controller module 40 alone, or to the communication link 50 alone.

In one example of operation, a user can manually adjust a position of the slider 202 along the switch path 204, causing the encoder 222 to rotate by way of the threaded shaft 215. The position sensor 221 can sense or detect such rotation of the encoder 222 and provide a signal indicative of a position of the slider 202.

In another example of operation, the switch motor 218 can drive rotation of the threaded shaft 215 such that the slider 202 is moved to a predetermined position along the switch path 204. For instance, the switch motor 218 can be remotely controlled or operated by way of the remote device 60 (FIG. 1) and the communication link 50.

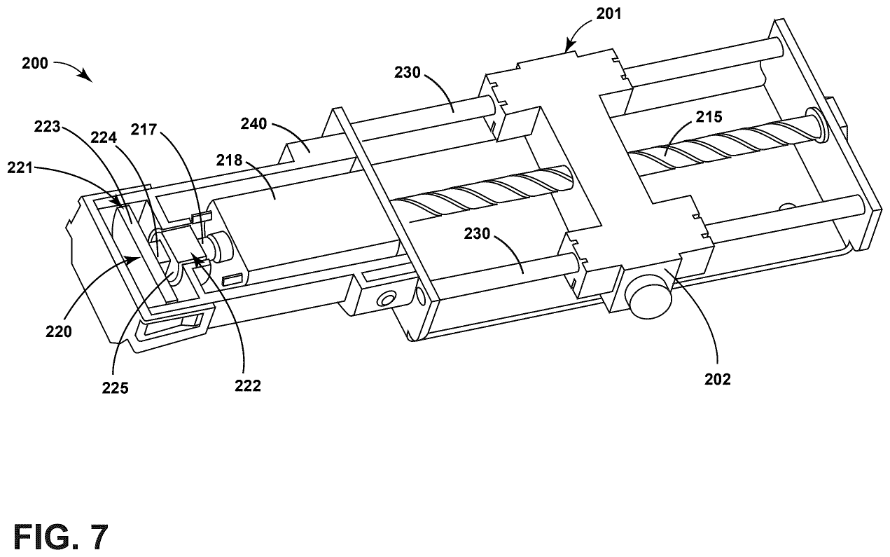

FIG. 7 illustrates one exemplary implementation of the control switch assembly 200. A pair of guide rails 230 can be provided for motion of the slider 202 along the switch path 204. A motor housing 240 is also provided, with the switch motor 218 and position sensor assembly 220 disposed therein.

In the illustrated example, the position sensor 221 includes an angular Hall sensor 223 and a PCB 224, and the encoder 222 includes a ring magnet 225. The angular Hall sensor 223 can sense a rotational position or orientation of the ring magnet 225, which corresponds to a position of the slider 202 as described above. In this manner, the position sensor assembly 220 can be configured to sense a position of the slider 202 at any location along the switch path 204. In another exemplary implementation, the position sensor 221 can include a pair of Hall sensors in place of the angular Hall sensor 223, and the encoder 222 can include a ring magnet having two or more circumferentially-arranged magnetic poles. In such a case, the controller module 40 can receive or compare signals from each Hall sensor and determine a speed of the ring magnet, or a rotational direction of the ring magnet, or the like.

The switch path 204 can also have multiple configurations, including a discrete-speed configuration and a continuous-speed configuration providing for stepped or continuous motor speed adjustments, respectively. In the discrete-speed configuration, the switch motor 218 can be operated to resist manual motion of the threaded shaft 215 when the slider 202 is between discrete stops, and to reduce or remove motion resistance of the shaft 215 when the slider 202 is in proximity to one or more of the discrete stops 205. In this manner, the switch motor 218 can electrically define motion detents at discrete positions along the switch path 204. In the continuous-speed configuration, the switch motor 218 can be operated to reduce or remove motion resistance of the threaded shaft 215 with no motion detents along at least a portion of the switch path 204. The slider 202 can be smoothly moved or positioned at any suitable location along the switch path 204 for selecting a speed of the motor 22 (FIG. 1).

Furthermore, the switch motor 218 can be communicatively coupled to either or both of the user interface 30 or the remote user interface 62 for selective operation. For instance, either or both of the user interface 30 or the remote user interface 62 can include a user-selectable option to select a configuration for the switch path 204, e.g. the discrete-speed or continuous-speed configuration, or to operate the switch assembly 200 in the selected configuration.

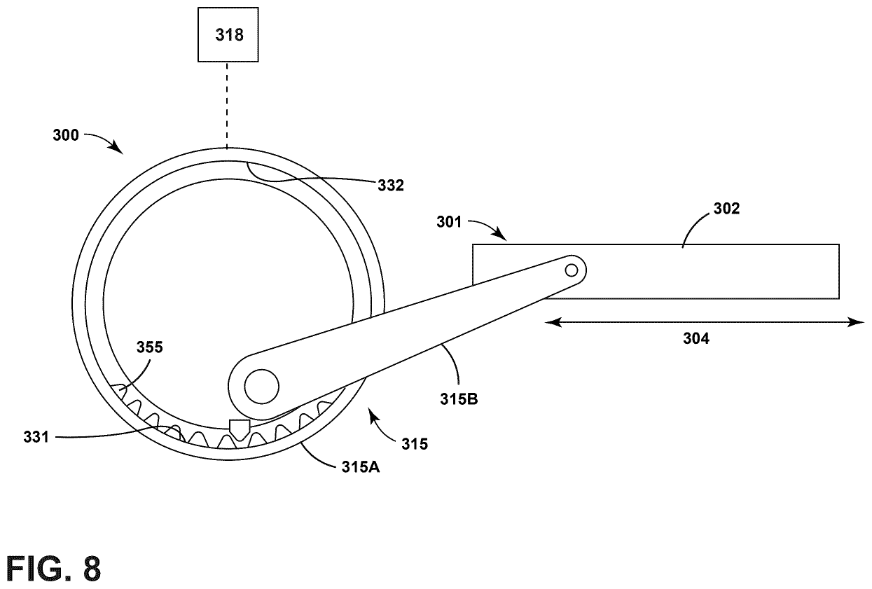

Turning to FIG. 8, another control switch assembly 300 is shown that can be utilized in the mixing appliance 10. The control switch assembly 300 is similar to the control switch assembly 100, 200; therefore, like parts will be described with like numerals further increased by 100, with it being understood that the description of the like parts of the control switch assembly 100, 200 applies to the control switch assembly 300, unless noted otherwise.

In the example shown, the switch assembly 300 includes an actuator 301, such as a slider 302 movable along a switch path 304, as well as a switch motor 318 that can drive motion of the slider 302. One difference compared to the switch assembly 100, 200 is that a cam link 315 is provided coupling the slider 302 to the switch motor 318. The cam link 315 can include a rounded track 315A and a linkage 315B coupled to the slider 302.

In the illustrated example, the track 315A includes a first portion 331 with motion detents 355, and a second portion 332 with no motion detents. While the first portion 331 is shown with mechanical detents, it is also contemplated that a switch motor can generate electrical detents along the switch path 304. When the linkage 315B is engaged with the first portion 331, the slider 302 can be movable along the switch path 304 between discrete positions corresponding to the mechanical detents. When the linkage 315B is engaged with the second portion 332, the slider 302 can be continuously or smoothly movable along the switch path 304. In this manner, the switch path 304 can have a discrete-speed configuration and a continuous-speed configuration by way of the track 315A.

It is further contemplated that the switch assembly 300 can be communicatively coupled to the controller module 40 or the remote device 60 (FIG. 1). For instance, it is contemplated that a position sensor assembly, similar to the position sensor assemblies 120, 220, can be provided for sensing or detecting a position of the actuator 301 along the switch path 304. Such a position sensor assembly can provide an output signal indicative of a position of the actuator 301 to the controller module 40 or to the remote device 60 (FIG. 1) as described above.

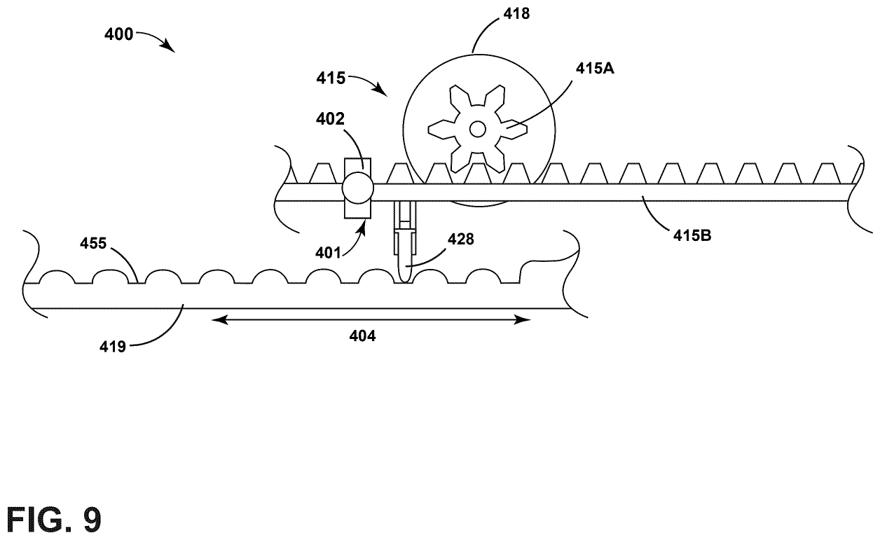

Turning to FIG. 9, another control switch assembly 400 is shown that can be utilized in the mixing appliance 10. The control switch assembly 400 is similar to the control switch assembly 100, 200, 300; therefore, like parts will be described with like numerals further increased by 100, with it being understood that the description of the like parts of the control switch assembly 100, 200, 300 applies to the control switch assembly 400, unless noted otherwise.

In the example shown, the switch assembly 400 includes an actuator 401 in the form of a slider 402 movable along a switch path 404, as well as a switch motor 418 that can drive motion of the slider 402. One difference compared to the switch assembly 100, 200, 300 is that a rack and pinion 415 is provided for coupling the slider 402 to the switch motor 418. The rack and pinion 415 can include a gear 415A coupled to the switch motor 418, and a rack 415B engaging the gear 415A and coupled to the slider 402.

The switch assembly 400 further includes a track 419 having motion detents 455, and a locator 428 configured to extend and retract over the motion detents 455 when the slider 402 is moved. The locator 428 can be selectively engaged or disengaged with the track 419. For instance, the rack and pinion 415 can be lifted in or out of engagement with the track 419, such as by a manual or electric switch. In such a case, the locator 428 can be engaged with detents 455 on the track 419 in a discrete-speed configuration, and can also be disengaged from such detents 455 in a continuous-speed configuration.

Still further, it is contemplated that the switch assembly 400 can be communicatively coupled to the controller module 40 or the remote device 60 (FIG. 1). For instance, it is contemplated that a position sensor assembly, similar to the position sensor assemblies 120, 220, can be provided for sensing or detecting a position of the actuator 401. Such a position sensor assembly can provide an output signal indicative of a position of the actuator 401 to the controller module 40 or to the remote device 60 (FIG. 1) as described above.

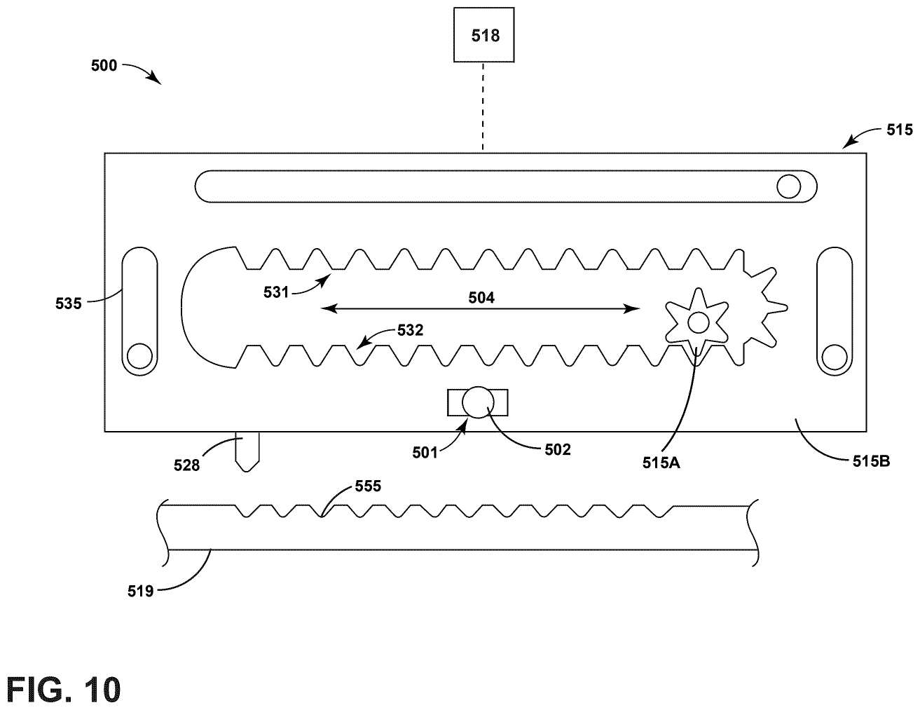

Turning to FIG. 10, another control switch assembly 500 is shown that can be utilized in the mixing appliance 10. The control switch assembly 500 is similar to the control switch assembly 100, 200, 300, 400; therefore, like parts will be described with like numerals further increased by 100, with it being understood that the description of the like parts of the control switch assembly 100, 200, 300, 400 applies to the control switch assembly 500, unless noted otherwise.

In the example shown, the switch assembly 500 includes an actuator 501, such as a slider 502, and a switch motor 518 that can drive motion of the slider 502. One difference compared to the switch assembly 100, 200, 300, 400 is that a reciprocating rack and pinion 515 is provided for coupling the slider 502 to the switch motor 518. The reciprocating rack and pinion 515 can include a gear 515A coupled to the switch motor 518, and a rack 515B engaging the gear 515A and coupled to the slider 502. The rack 515B defines a switch path 504 as shown.

The switch assembly 500 further includes a track 519 having motion detents 555, and a locator 528 configured to extend and retract over the motion detents 555 when the slider 502 is moved. The locator 528 can be selectively engaged or disengaged with the track 519. For instance, the locator 528 can be engaged with the detents 555 in a discrete-speed configuration, and can also be disengaged from such detents 555 in a continuous-speed configuration.

In addition, vertical channels 535 are provided in the rack 515B for selective raising or lowering of the rack 515B. More specifically, the rack 515B can include a first portion 531 and a second portion 532 selectively engaging the gear 515A. When the gear 515A is located along the first portion 531, the locator 528 engages with the detents 555 on the track 519 and defines a first configuration of the switch path 504, i.e. a discrete-speed configuration. When the gear 515A is located along the second portion 532, the locator 521 is spaced from the track 519 and defines a second configuration of the switch path 504, i.e. a continuous-speed configuration.

Still further, it is contemplated that the switch assembly 500 can be communicatively coupled to the controller module 40 or the remote device 60 (FIG. 1). For instance, it is contemplated that a position sensor assembly, similar to the position sensor assemblies 120, 220, can be provided for sensing or detecting a position of the actuator 501. Such a position sensor assembly can provide an output signal indicative of a position of the actuator 501 to the controller module 40 or to the remote device 60 as described above.

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

This written description uses examples to disclose aspects of the disclosure, including the best mode, and also to enable any person skilled in the art to practice aspects of the disclosure, including making and using any devices or systems and performing any incorporated methods. The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An electric mixing appliance, comprising:
a drive shaft configured to couple to a mixing tool;
an electric motor operably coupled to the drive shaft for driving rotation of the drive shaft;
a control switch assembly operably coupled to the electric motor and comprising:
a switch path selectively defining a first configuration with motion detents, and a second configuration without motion detents;
a position sensor assembly configured to sense a position of the actuator along the switch path; and
a controller module communicatively coupled to the electric motor and the position sensor assembly, and configured to operate the electric motor based on the sensed position.

2. The electric mixing appliance of claim 1, wherein the position sensor assembly comprises an encoder operably coupled to the actuator, and at least one position sensor configured to provide an output signal indicative of the position of the actuator along the switch path based on the encoder.

3. The electric mixing appliance of claim 2, wherein the encoder comprises a ring magnet, and wherein the at least one position sensor comprises an angular Hall-effect sensor.

4. The electric mixing appliance of claim 1, further comprising a switch motor operably coupled to the actuator for driving motion along the switch path.

5. The electric mixing appliance of claim 4, further comprising an encoder operably coupled to the switch motor, and a Hall-effect sensor sensing an orientation of the encoder.

6. The electric mixing appliance of claim 5, further comprising:
a housing carrying at least the drive shaft, the electric motor, and the control switch assembly; and
a channel in the housing, with the actuator extending through the channel for exterior access.

7. The electric mixing appliance of claim 4, further comprising a communication link operably coupled to the control switch assembly and configured for signal communication with a remote device.

8. The electric mixing appliance of claim 7, wherein the remote device is configured to controllably operate the actuator by way of the switch motor.

9. The electric mixing appliance of claim 4, wherein the switch motor is configured to electrically generate the motion detents as resistance to motion of the actuator.

10. The electric mixing appliance of claim 4, further comprising a belt carrying the actuator, and at least one pulley operably coupled to the switch motor, wherein one of the belt or the switch motor drives the other of the belt or the switch motor.

11. The electric mixing appliance of claim 4, further comprising a threaded shaft carrying the actuator and operably coupled to the switch motor, wherein one of the threaded shaft or the switch motor drives the other of the threaded shaft or the switch motor.

12. The electric mixing appliance of claim 1, wherein the switch path comprises a track with a first portion having mechanical detents defining the motion detents, and a second portion without motion detents.

13. A control switch assembly for an electric mixing appliance, comprising:
a switch path defining at least two positions corresponding to an operational speed of the electric mixing appliance;
a slider movable along the switch path;
a switch motor operably coupled to the slider for driving motion along the switch path; and
a position sensor assembly configured to sense a position of the slider along the switch path;
wherein the switch path selectively defines a first configuration having motion detents, and a second configuration without motion detents.

14. The control switch assembly of claim 13, wherein the position sensor assembly comprises a Hall-effect sensor.

15. The control switch assembly of claim 14, wherein the position sensor assembly further comprises an encoder operably coupled to the switch motor.

16. The control switch assembly of claim 15, wherein the position sensor comprises an angular Hall-effect sensor, and the encoder comprises a ring magnet.

17. The control switch assembly of claim 13, wherein the switch motor is configured to generate the motion detents as electric detents in the first configuration of the switch path.

18. The control switch assembly of claim 13, further comprising a belt and at least one pulley operably coupled to the slider and the switch motor, wherein one of the belt or the switch motor drives the other of the belt or the switch motor.

19. The control switch assembly of claim 13, further comprising a threaded shaft carrying the slider and operably coupled to the switch motor, wherein one of the threaded shaft or the switch motor drives the other of the threaded shaft or the switch motor.

20. The control switch assembly of claim 13, wherein the switch motor is configured to electrically generate the motion detents as resistance to motion of the slider.
